(19) United States
(12) Patent Application Publication
(10) Pub. No.: US 2025/0328796 A1
(43) Pub. Date: Oct. 23, 2025

(54) QUANTUM PROCESSING UNIT

(71) Applicant: IQM Finland Oy, Espoo (FI)

(72) Inventors: Vicente PINA CANELLES, Espoo (FI); Adrian AUER, Espoo (FI); Martin LEIB, Espoo (FI); Ines DE VEGA, Espoo (FI)

(21) Appl. No.: 18/593,238

(22) Filed: Mar. 1, 2024

(30) Foreign Application Priority Data
Mar. 3, 2023 (FI) 20235255

(51) Int. Cl. G06N 10/40; G06N 10/20; G06N 10/60

(52) U.S. Cl. CPC G06N 10/40; G06N 10/20; G06N 10/60

(57) ABSTRACT

The invention relates to the field of quantum computing and more specifically to a quantum processing unit adapted for performing a quantum phase estimation algorithm. The quantum processing unit includes a plurality of register qubits and a plurality of memory qubits. A first register qubit is directly connected to every other register qubit and to every memory qubit. Controlled operations performed on the memory qubits and different register quantum states stored in the register qubits are performed by swapping the different register quantum states into the first register qubit and performing the controlled operations on the first register qubit and the plurality of memory qubits.

### TECHNICAL FIELD

The invention relates to the field of quantum computing and more specifically to a quantum processing unit adapted for performing a quantum phase estimation algorithm.

### BACKGROUND

In the current noisy intermediate-scale quantum (NISQ) era, quantum processors are not sufficiently robust against noise sources to handle algorithms with arbitrary depth, therefore limiting the depth of algorithms that can be effectively implemented. Furthermore, certain gates, such as SWAP gates, are extremely expensive in terms of quantum resources since they are not native and must be decomposed into other native entangling gates.

Quantum phase estimation is a quantum algorithm for estimating the phase of an eigenvector of a unitary operator. It is an important building block in other quantum algorithm's, such as Shor's algorithm for integer factorization and the Harrow-Hassidim-Lloyd algorithm for solving systems of linear equations.

The basic quantum phase estimation algorithm is described in detail in Chapter 5, part 5.2 of “Quantum Computation and Quantum Information”, Michael Nielsen & Isaac Chuang, ISBN 978-1-107-00217-3. The basic algorithm uses a first set of qubits referred to as register qubits and a second set of qubits referred to as memory qubits. The number of register qubits is selected based on the number of digits of accuracy required for the phase estimation and to increase the probability of success of the phase estimation algorithm. The number of memory qubits is selected such that the eigenstate |u> of a the unitary operator U can be stored in the memory qubits. The eigenvalue (or phase) of the eigenstate |u> is estimated by applying the quantum phase estimation algorithm.

### SUMMARY OF THE INVENTION

A first aspect of the invention relates to a quantum processing unit for performing a quantum phase estimation algorithm. The quantum processing unit comprises a first qubit q₀ and a plurality of second qubits q₁ to qₘ₊ₙ, wherein:
the plurality of second qubits comprises a first subset of second qubits q₁ to qₘ and a second subset of second qubits qₘ₊₁ to qₘ₊ₙ;
the first qubit q₀ is directly coupled to a plurality of second qubit in the first subset of second qubits q₁ to qₘ;
the first qubit q₀ is directly coupled to a plurality of second qubits in the second subset of second qubits qₘ₊₁ to qₘ₊ₙ;
each second qubit in the first subset of second qubits is coupled directly or indirectly to every other second qubit in the first subset of second qubits via one or more other second qubits in the first subset of second qubits; and
each second qubit in the second subset of second qubits is coupled directly or indirectly to every other second qubit in the second subset of second qubits via one or more other second qubits in the second subset of second qubits.

The first qubit q₀ may be directly coupled to every qubit in the first subset of second qubits. The first qubit q₀ may also or alternatively be directly coupled to every qubit in the second subset of second qubits.

The first subset of second qubits and the second subset of second qubits may be connected such that each of the second qubits is coupled directly or indirectly to every other second qubit via other second qubits.

At least one second qubit of the first subset of second qubits may be directly coupled to one second qubit of the second subset of second qubits. In some cases, only one second qubit of the first subset of second qubits is directly coupled to one second qubit of the second subset of second qubits. Alternatively, two second qubits of the first subset of second qubits may be directly coupled to second qubits of the second subset of second qubits, such that each second qubit of the first subset of second qubits is directly coupled to one second qubit of the second subset, and each second qubit of the first subset of second qubits is directly coupled to a different second qubit of the second subset.

The second qubits in the first subset of second qubits may be coupled in a first two-degree chain such that the first and last second qubits in the chain are directly coupled to one other second qubit in the first subset of second qubits, and all other second qubits in the chain are connected to two other second qubits in the first subset of second qubits.

The second qubits q₁ to qₘ in the first subset of second qubits may be arranged in a four-degree chain such that all second qubits qₖ except for second qubits q₁, q₂, qₘ₋₁ and qₘ are connected to four other second qubits qₖ₋₂, qₖ₋₁, qₖ₊₁ and qₖ₊₂.

The second qubits in the second subset of second qubits may be coupled in a second two-degree chain such that the first and last second qubits in the chain are directly coupled to one other second qubit in the second subset of second qubits, and all other second qubits in the chain are connected to two other second qubits in the second subset of second qubits.

The first second qubit in the first chain may be directly coupled to the first second qubit in second chain and/or the last second qubit in the first chain may be directly coupled to the last second qubit in the second chain.

The first qubit q₀ may be physically configured as at least one resonator. The second qubits q₁ to qₘ₊ₙ may be coupled to the at least one resonator at positions corresponding to maxima of the standing electromagnetic wave formed within the at least one resonator.

The first qubit q₀ may be physically configured as at least one physical qubit.

A second aspect of the invention related to a method for performing a quantum phase estimation algorithm on the quantum processing unit of any preceding claim. The method comprises:
performing a Hadamard gate on each quantum state in a plurality of register quantum states, each of which has been initialized in the ground state |0 [symbol] , wherein the register quantum states are stored in the first subset of second qubits and in the first qubit (q₀);
performing controlled operations on a plurality of memory quantum states stored in the second subset of second qubits by repeatedly swapping the register quantum state stored in the first qubit (q₀) and performing each controlled operation on the first qubit (q₀) and second subset of second qubits, wherein each controlled operation depending on the state of a different one of the register quantum states, wherein the controlled operation corresponds to a unitary (U), and wherein the initial state of the memory quantum states corresponds to an eigenstate (|u [symbol] ) of the unitary; and
performing an inverse quantum Fourier transform on the register quantum states.

The method may further comprise measuring the register quantum states to obtain the eigenvalue of the eigenstate |u [symbol] of the unitary U.

The controlled operation may applies the unitary to the memory quantum states only if the quantum state of the first qubit is |1 [symbol] .

The first qubit q₀ may be physically configured as at least one resonator and the register quantum states may be stored in the first subset of second qubits and in the first qubit q₀. Performing a Hadamard gate on each quantum state in the plurality of register quantum states may comprise:
performing Hadamard gates on the register quantum states in the first subset of second qubits;
swapping the register quantum states of the first qubit (q₀) and one second qubit of the first subset of second qubits; and
performing a Hadamard gate on the swapped quantum state originally in the first qubit (q₀).

At least one second qubit of the first subset of second qubits may be directly coupled to one second qubit of the second subset of second qubits, and either:
the register quantum states may also be stored in some of the second qubits of the second subset of second qubits; or
the memory quantum states may also be stored in some of the second qubits of the first subset of second qubits.

The method may further comprise selecting the number of second qubits used to store the register quantum states and/or the number of second qubits used to store the memory quantum states.

The quantum phase estimation algorithm may be performed as part of a Harrow-Hassidim-Lloyd algorithm, and one second qubit from the first subset of second qubits or one second qubit from the second subset of second qubits may be used as an ancillary qubit for performing the ancilla quantum encoding subroutine of the Harrow-Hassidim-Lloyd algorithm.

A third aspect of the invention relates to a computer system configured to perform the method set out above.

A fourth aspect of the invention relates to a computer system comprising a classical processing unit and a quantum processing unit, the classical processing unit being configured to provide control signals to the quantum processing unit such that the quantum processing unit performs the method set out above.

A fifth aspect of the invention relates to quantum processing unit configured to perform the method set out above.

A sixth aspect of the invention relates to a computer program product comprising instructions which, when executed by a computer, cause the computer to perform the method set out above.

A seventh aspect of the invention relates to a computer-readable medium comprising instructions which, when executed by a computer, cause the computer to perform the method set out above.

### BRIEF DESCRIPTION OF THE DRAWINGS

FIG. 1A is a schematic diagram of a first quantum processing unit topology according to the invention.

FIG. 1B is a schematic diagram of a second quantum processing unit topology according to the invention.

FIG. 2 is a schematic diagram of a third quantum processing unit topology according to the invention.

FIG. 3 is a schematic diagram of a first arrangement of qubits coupled to a resonator via tuneable couplers according to the invention.

FIG. 4 is a schematic diagram of a second arrangement of qubits coupled to a resonator via tuneable couplers according to the invention.

FIG. 5 is a schematic diagram of a third arrangement of qubits coupled to a resonator via tuneable couplers according to the invention.

FIG. 6 is a schematic diagram of a fourth quantum processing unit topology according to the invention.

FIG. 7 is a quantum circuit diagram showing the arrangement of two-qubit gates for a quantum Fourier transform performed on the quantum processing unit of FIG. 6 according to the invention.

FIG. 8 is a flow chart depicting a method of performing a quantum Fourier transform on the quantum processing unit of 6 according to the invention.

FIG. 9 is a quantum circuit diagram showing a first method of performing the quantum phase estimation algorithm according to the invention.

FIG. 10 is a quantum circuit diagram showing a second method of performing the quantum phase estimation algorithm according to the invention.

### DETAILED DESCRIPTION OF THE INVENTION

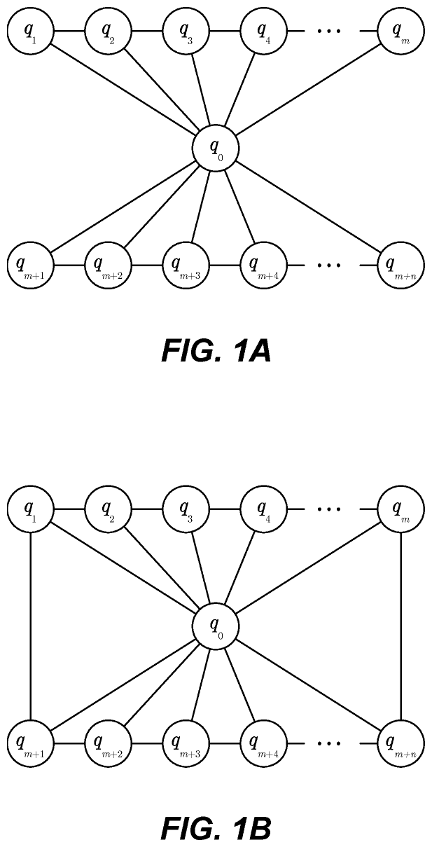

FIGS. 1A and 1B are schematic diagrams showing the topology of a quantum processing unit (QPU) according a first embodiment of the invention. The QPU is adapted for performing a quantum phase estimation algorithm. The QPU includes a first qubit q₀, which may also be referred to as a “central qubit” or “hub qubit”. The terms “central qubit” and “hub qubit” refer to the logical arrangement of the first qubit with respect to other qubits in the QPU and should not be seen as limiting on the physical location of the first qubit. The QPU also includes multiple second qubits q₁ to qₘ₊ₙ.

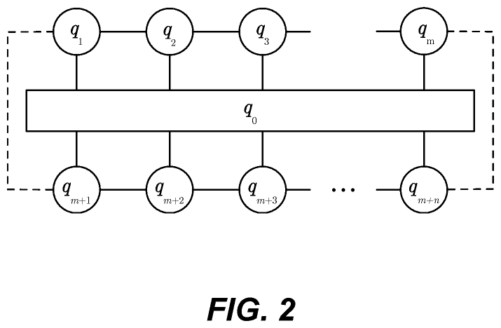

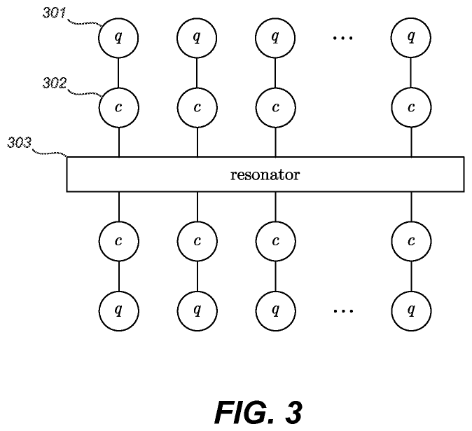

The qubits shown in FIGS. 1A and 1B (and in FIGS. 2 and 3 described below) are logical qubits. A logical qubit may be made up of one or more physical qubits which are treated as a single “logical” qubit in the context of a quantum algorithm. In this sense, a logical qubit may be physically configured, i.e. implemented, as one or more physical qubits or other suitable elements. A physical qubit may be a superconducting qubit, such as a transmon qubit, trapped ion qubit, or any other quantum mechanical system that can store quantum mechanical basis states, including superpositions of the basis states. In the current NISQ era, limitations on coherence time and/or the number of direct couplings between physical qubits that are possible may require that a single logical qubit be formed of multiple physical qubits. For example, where a single logical qubit has many direct couplings to other logical qubits, it may not be physically possible to provide all of the couplings from a single physical qubit, e.g. due to frequency crowding limiting the ability to individually address specific qubit-qubit pairs. In this case, the direct couplings of the logical qubit may be shared between physical qubits that make up the logical qubit. Furthermore, limited coherence times of physical qubits may be overcome by applying quantum error correction across multiple physical qubits within a single error-tolerant logical qubit.

As shown in FIGS. 1A and 1B, each of the second qubits q₁ to qₘ₊ₙ is directly coupled to the first qubit, as indicated by the solid lines shown in FIGS. 1A and 1B. However, in other embodiments, some of the second qubits may be connected only indirectly, i.e. via one or more other second qubits, to the first qubit.

The second qubits are logically divided into a first subset q₁ to qₘ and a second subset qₘ₊₁ to qₘ₊ₙ. The first subset contains m qubits and the second subset contains n qubits. Within each subset of second qubits, every qubit is connected directly of indirectly to other second qubits in the subset. In other words, in the first subset of second qubits, every qubit is coupled to every other qubit either directly or indirectly via one or more other qubits in the first subset of qubits. For example, as shown in FIG. 1A, qubit q₁ is coupled directly to qubit q₂ and indirectly to qubit q₃ via qubit q₂. In the second subset of second qubits, every qubit is coupled to every other qubit either directly or indirectly via one or more other qubits. For example, qubit qₘ₊₁ is coupled directly to qubit qₘ₊₂ and indirectly to qubit qₘ₊₃ via qubit qₘ₊₂.

In the QPU of FIG. 1A, the qubits of the first subset of second qubits q₁ to qₘ are arranged in a two-degree chain, i.e. a linear chain, in which each qubit except for the first qubit and last qubit in the chain is directly coupled to two other qubit. For example, as shown in FIG. 1A, within the first subset of second qubits, qubit q₁ is directly coupled to qubit q₂ only and qubit qₘ is directly coupled to qubit qₘ₋₁ only. For all remaining qubits qₖ in the first subset of second qubits, where 1<k<m, qubit qₖ is directly connected to qubits qₖ₋₁ and qₖ+1. Also in the QPU of FIG. 1A, the qubits of the second subset of second qubits qₘ₊₁ to qₘ₊ₙ are arranged in a two-degree chain, i.e. a linear chain, in which each qubit except for the first qubit and last qubit in the chain is directly coupled to two other qubit. For example, as shown in FIG. 1A, within the second subset of second qubits, qubit qₘ₊₁ is directly coupled to qubit qₘ₊₂ only and qubit qₘ₊ₙ is directly coupled to qubit qₘ₊ₙ₋₁ only. For all remaining qubits qₖ in the second subset of second qubits, where m+1<k<m+n, qubit qₖ is directly connected to qubits qₖ₋₁ and qₖ₊₁. Other arrangements of qubits in each of the first subset of second qubits and second subset of second qubits may be used, as long as every qubit in the first subset of second qubits is coupled to every other qubit in the first subset of second qubits, either directly or indirectly via one or more other qubits in the first subset of qubits, and as long as every qubit in the second subset of second qubits is coupled to every other qubit in the second subset of second qubits, either directly or indirectly via one or more other qubits in the first subset of qubits. Furthermore, it is not essential that both the first subset of second qubits and second subset of second qubits have the same coupling topology, either within the subsets or in the couplings between the second qubits and the first qubit.

The first subset of second qubits and second subset of second qubits are separated by the first qubit q₀, i.e. such that there are no direct couplings between a qubit in the first subset of second qubits and second subset of second qubits and no indirect couplings between a qubit in the first subset of second qubits and second subset of second qubits except via the first qubit q₀. Alternatively, as shown in FIG. 1B, the first subset of second qubits and second subset of second qubits may be connected such that each of the second qubit in both subsets is coupled either directly or indirectly via other second qubits to every other second qubit in both subsets. FIG. 1B shows two direct couplings between the first subset of second qubits and second subset of second qubits. A first direct coupling is provided between qubit q₁ in the first subset of second qubits and qubit qₘ₊₁ in the second subset of second qubits. A second direct coupling is provided between qubit qₘ in the first subset of second qubits and qubit qₘ₊ₙ in the second subset of second qubits. While FIG. 1B shows two such direct couplings between the first subset of second qubits and second subset of second qubits, a single direct coupling may be present, or more than two direct couplings may be present. Where the first subset of second qubits and second subset of second qubits are both arranged in two-degree chains, as described above and as depicted in FIG. 1B, the first qubit in the chain of the first subset may be directly coupled to the first qubit in the chain of the second subset. Additionally, or alternatively, the last qubit in the chain of the first subset may be directly coupled to the last qubit in the chain of the second subset. It will be appreciated that the designation of “first” and “last” elements in the chain are essentially arbitrary and the chain has no intrinsic directionality. As such, it could also be said that the first qubit in the chain of the first subset may be directly coupled to the last qubit in the chain of the second subset and/or the last qubit in the chain of the first subset may be directly coupled to the first qubit in the chain of the second subset.

Additional direct couplings between the qubits of the first subset of second qubits and second subset of second qubits may also be present. Multiple or even every qubit in the first subset of second qubits may be directly connected to a different one of the qubits in the second subset of second qubits. For example, in the QPU of FIG. 1B, each qubit pair consisting of a qubit from the first subset and a qubit from the second subset qᵢ, qₘ₊ᵢ may be directly coupled while maintaining two-dimensional connectivity, i.e. without crossing couplings.

FIG. 2 depicts a second embodiment of the invention corresponding to the embodiment of FIG. 1A or 1B with the modification that the first qubit q₀ is implemented as a resonator to which the second qubits are coupled. The description of the QPU of FIGS. 1A and 1B above is therefore equally applicable to the QPU of FIG. 2. The resonator may be, for example, a superconducting coplanar waveguide resonator. Such a resonator is formed of a single conducting track with a pair of return conductors, one located on each side of the conducting track. Boundary conditions or either zero current or zero voltage are imposed at the ends of the conducting track, giving rise to a set of resonant frequencies that match the boundary conditions. The resonator mode frequency is close to the frequency of the second qubits.

The second qubits may be coupled to the resonator via tuneable couplers. The default frequency or frequencies of the tuneable couplers are higher or lower than the frequency of the second qubits. By tuning the frequency of a tuneable coupler to match the frequency of the connected second qubit and the resonator, interactions between the resonator and connected second qubit are turned on and a Rabi swap is performed between the connected second qubit and the resonator, in which the quantum states stored in the connected second qubit and resonator are swapped. This operation is equivalent to a two-qubit iSWAP gate and the resulting qubit state in the qubit may be corrected to correspond to the state originally stored in the resonator by applying a suitable single qubit gate.

Alternatively, the second qubits may be coupled capacitively to the resonator and each of the second qubits may have a different qubit frequency, different also to the resonator frequency. By tuning the qubit frequency of a given second qubit to match the resonator frequency, quantum states may be swapped between the second qubit and the resonator. However, using tuneable couplers significantly increases the number of second qubits that can be directly connected to the resonator beyond direct capacitive coupling.

Couplings between the second qubits and resonator are located at positions along the resonator that correspond to the positions of voltage maxima of the electromagnetic standing wave that arises within the resonator. Preferably the couplings are located within a region ±10% of the wavelength of the standing wave around each maximum. The couplings, however, located within a region up to +20% of the wavelength of the standing wave around each maximum. By scaling the length of the resonator, the number of maxima within the resonator can be increased, providing more locations at which second qubits can be coupled to the resonator. Second qubits can be coupled to the resonator on each side of the resonator. To further increase the number of second qubits that can be coupled to first qubit q₀, the first qubit q₀ may be made up of multiple coupled resonators, which are coupled to one another by one or more tuneable couplings made up of a first tuneable coupler, and intermediate qubit and a second tuneable coupler.

FIG. 3 shows a schematic representation of the arrangement of qubits and a resonator in according with the embodiment depicted in FIG. 2. Individual qubits 301 (shown as black circles) are coupled via tuneable couplers 302 (shown as white circles) to a resonator 303. The qubits 301 may be, for example, transmon qubits, as described in detail in Koch et al., Charge-insensitive qubit design derived from the Cooper pair box, Phys. Rev. A 76, 042319 (doi: 10.1103/PhysRevA.76.042319). The tuneable couplers 302 may also be transmons, or other coupling circuits whose frequency characteristics can be externally controlled so as to selectively couple each qubit 301 to the resonator 303, i.e. such that the coupling can be “on” or “off” as required.

The resonator 303 may be, for example, a superconducting coplanar waveguide resonator. The resonator mode frequency is close to the frequency of the qubits 301, while the default frequency of the tuneable couplers 302 is higher or lower than the frequency of the qubits 301. Preferably, the frequency difference between the qubits 301 and the resonator 303 is less than the absolute value of the anharmonicity of the qubit 301. For a transmon qubit, this is a negative value of approx. 2% of the transition frequency between the |0) state and |1) state.

The tuneable couplers 302 are located at positions along the resonator 303 that correspond to the positions of voltage maxima of the electromagnetic standing wave that arises within the resonator 303. Preferably the tuneable couplers 302 (and any direct qubit connections) to the resonator 303 are located within a region ±10% of the wavelength of the standing wave around each maximum. The tuneable couplers 302 (and any direct qubit connections) to the resonator 303 may, however, located within a region up to +20% of the wavelength of the standing wave around each maximum. Thus, by scaling the length of the resonator 303, the number of maxima within the resonator can be increased, providing more locations at which qubits 301 can be coupled to the resonator 303 via tuneable couplers 302. Qubits 301 can be coupled to the resonator 303 (via the tuneable coupler 302) on each side of the resonator 303, as shown in FIG. 3. While FIG. 3 shows one qubit/tuneable coupler connected on each side of the resonator at a single location, up to 20 qubits can be connected to the resonator at each maximum.

States may be swapped between the qubits and resonator by tuning the tuneable coupler 302 to couple a qubit to the resonator 303 for the specific length of time required to effectively transfer the first state from the qubit to the resonator 303.

As an alternative to using tuneable couplers, the qubits may be directly coupled to the resonator 303 by a capacitor, i.e. without an intermediate tuneable coupler. The frequency of a given qubit is brought into resonance with the resonator 303 in order to transfer the prepare first state from the qubit into the resonator 303 and vice versa.

Two qubit gate operations, such as a conditional phase gates, can be performed between the resonator and one or more of the other qubits by manipulating the tuneable couplers between the resonator and other qubits. In this way, the resonator is acting as an information storage component, rather than simply as an information bus as is commonly the case. Measurement can be performed by transferring the state of the resonator 303 back to the central qubit, or any qubit whose state can be measured. This arrangement therefore enables any of the qubits 301 to be coupled with any of the other qubits 301 via the resonator 303, and enables all-to-all coupling by swapping the state of each qubit 301 into the resonator sequentially. For applications and algorithms in which many-to-many couplings are required, this qubit arrangement significantly reduces the number of two qubit gate operations that must be performed compared to other qubit arrangements.

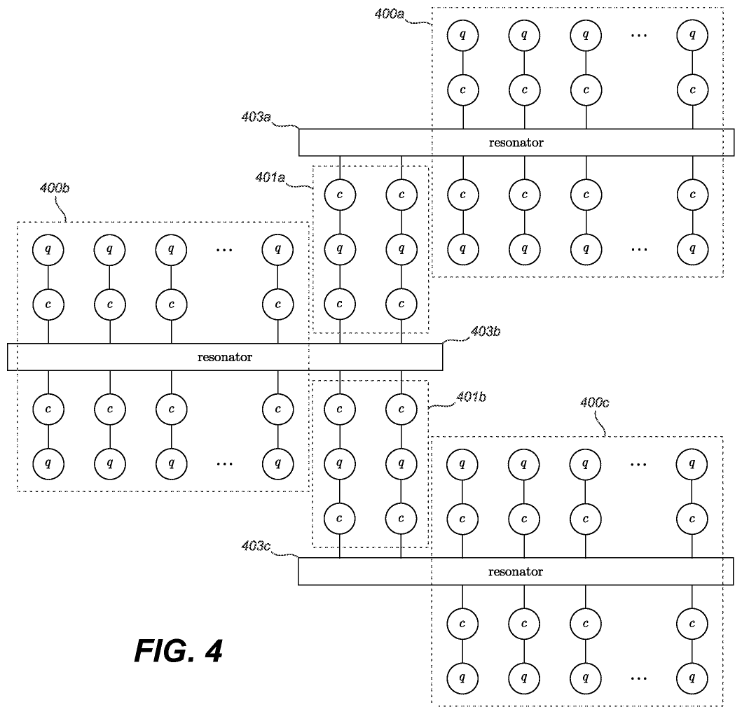

FIG. 3 shows eight qubits 301 and eight tuneable couplers 302, but it is possible to couple more qubits 301 and tuneable couplers 302 to a single resonator 303. The upper limit on the number of qubits that can be coupled to a single resonator is governed by the diminishing quality factor of the resonator 303 as its length increases and the frequency separation of the resonator modes compared with the qubit linewidths. To further increase the number of qubits 301 that can be coupled, multiple groups on qubits, couplers and resonators 400a-c may be coupled via the resonators 403a-c as shown in FIG. 4. Preferably, each resonator 403a-c is coupled to another resonator 403a-c by two CQC couplings 401a, 401b, where each CQC coupling includes a first tuneable coupler (C) a qubit (Q) and a second tuneable coupler (C) connected in series. Each tuneable coupler in the CQC coupling is connected to a different one of the resonators 403a-c, linking the two resonators 403a-c. The two CQC couplings in each set 401, 401b are arranged in parallel between the resonators. Each CQC coupling is connected to the resonators 403a-c at the maxima of the electromagnetic standing wave that forms within the resonator during operation. FIG. 4 shows three sets of qubits, couplers and resonators 400a-c, but further resonators may be coupled to any of the resonators 403a-c to form a chain of resonators or any other architecture.

The resonators 403a-c of sets 400a-c can alternatively be coupled by a single CQC coupling; however, a single CQC can be used to transfer a state from one resonator to the other if the target resonator is empty, i.e. in the ground state. To enable transfer of arbitrary states between both resonators, the two parallel paths provided by two CQC couplings as shown in FIG. 4 is needed. The limitations imposed by using a single CQC coupling between resonators may be desirable in certain application-specific implementations where the quantum algorithms run on the qubits do not require the transfer of arbitrary states between resonators, for example. Where two CQC couplings are provided between two resonators, the state from a first resonator is transferred into to the qubit of the first CQC coupling and the state from the second resonator is transferred into the qubit in in the second CQC coupling. The state from the qubit in the first CQC coupling is subsequently transferred into the second resonator, and the state from the second CQC coupling is transferred into the first resonator.

As a further alternative, the resonators may be connected by one CQC coupler and one direct coupler, i.e. a single tuneable coupler. The quantum state from a first resonator is transferred into the qubit in the CQC coupler, then an iSWAP gate operation is performed between the two resonators via the direct coupling to transfer the state from the second resonator into the first. Finally, the state held in the CQC qubit is transferred into the second resonator. Compared to a system with two CQC couplings joining the resonators, a single CQC coupling and a direct coupling result in a phase change in the state transferred via the direct coupling, whereas states transferred via the CQC couplings maintain the same phase.

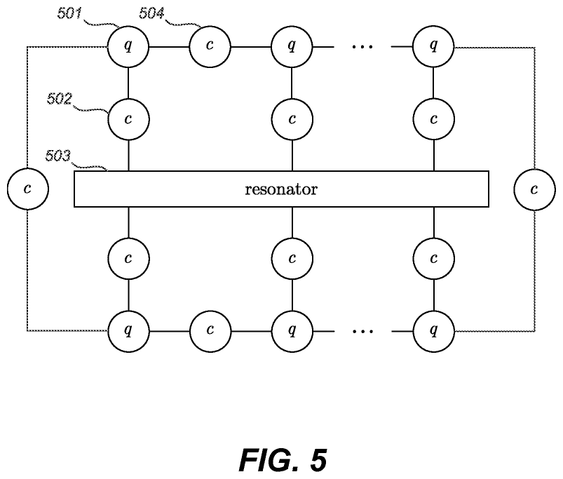

Direct couplings between the second qubits (i.e. not via the first qubit q₀, resonator 303) to other second qubits may also be implemented by tuneable couplers, as shown in FIG. 5. Alternatively, the coupling between qubits may be via capacitive or inductive coupling, i.e. without a tuneable coupler. FIG. 5 shows a simple example of a system including a single resonator 503 where the qubits 501 are coupled to the resonator 503 via tuneable couplers 502, but the qubits 501 are also directly coupled, i.e. not via the resonator 503, to adjacent qubits via tuneable couplers 504. Each qubit 501 may be directly coupled to as many as 6-10 other qubits as well as being coupled indirectly to other qubits 501 via the resonator 503. Furthermore, it will be appreciated that such direct qubit-qubit couplings may also be present in systems with multiple resonators 503, and such direct qubit-qubit couplings may exist between qubits connected to the same resonator and even different resonators.

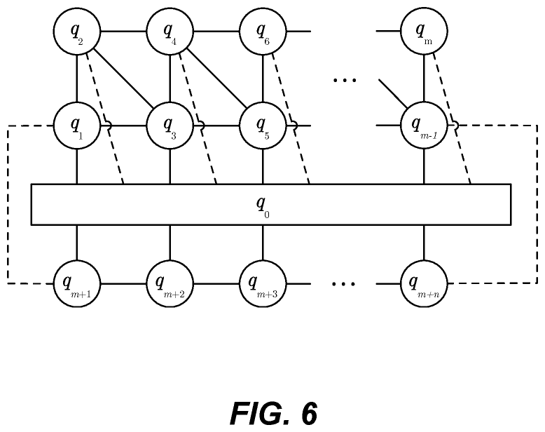

FIG. 6 shows a further embodiment of a QPU according to the present invention. The embodiment of FIG. 6 corresponds to that of FIGS. 1 and 2 with the modification that the first subset of second qubits q₁ to qₘ is arranged in a four-degree chain. Thus, aside from the specific arrangement of the first subset of second qubits described below, the description of FIGS. 1A-B and 2-5 above applies equally to the embodiment of FIG. 6.

According to the four-degree chain topology of the first subset of second qubits, all qubits in the first subset of second qubits except for the first qubit, second qubit, penultimate and final qubits in the chain are connected to four other qubits. Put another way, the quantum processing unit has m qubits q₁ to qₘ, of which all qubits qₖ except for the first qubit q₁, second qubit q₂, penultimate qubit qₘ₋₁ and final qubit qₘ are connected to four other qubits qₖ₋₂, qₖ₋₁, qₖ₊₁ and qₖ₊₂.

The first qubit q₁ is connected directly to qubit q₂ and q₃, the second qubit q₂ is connected directly to qubits q₁, q₃ and q₄. In FIG. 6, the penultimate qubit qₘ₋₁ is directly connected to qubits qₘ₋₃, qₘ₋₂ and qₘ, and the final qubit qₘ is directly connected to qubits qₘ₋₁ and qₘ₋₂.

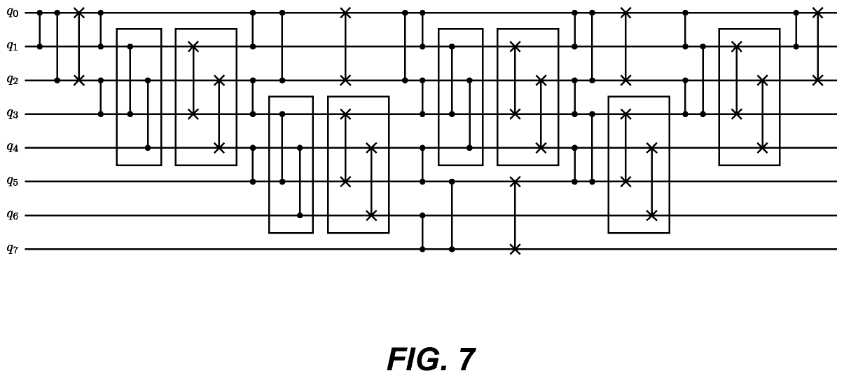

FIG. 7 is a quantum circuit diagram showing the exemplary arrangement of TQGs of a quantum Fourier transform performed on the first subset of second qubits of the QPU of FIG. 6. Two-qubit gates (TQGs) are indicated by connections between quantum wires for qubits q₀ to q₇. TQGs surrounded by a box with a solid border can be performed in parallel. In conventional quantum circuit diagrams a connection with a quantum wire indicated with a filled circle typically denotes a control connection, but in the diagram of FIG. 7 no such meaning is intended. The filled circle is merely used to indicate which quantum wires the TQGs interact with.

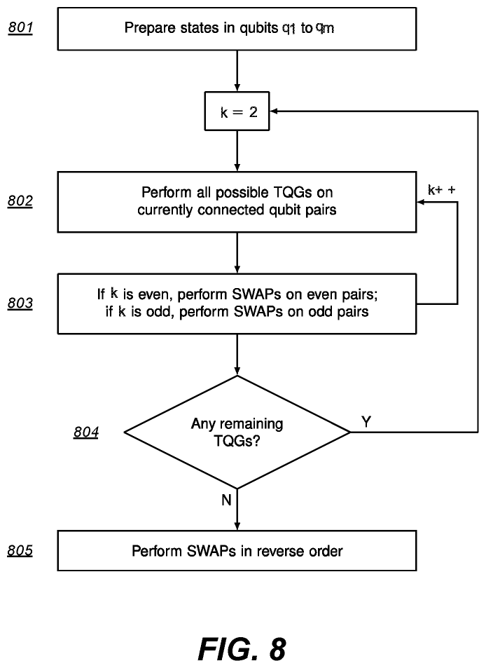

A generalized method for performing a quantum Fourier transform on a QPU with any number of qubits q₁ to qₘ with a topology consistent with the four-degree chain shown in FIG. 6 is depicted in FIG. 8.

At step 901, initial quantum states are prepared in the qubits q₁ to qₘ. Preparing the initial quantum states may comprise preparing |0 [symbol] states in each qubit and manipulating the qubit states by the application of quantum gates, such as Pauli X, Y and Z gates and the Hadamard gate H. In the context of the present invention, when the QFT is part of a quantum phase estimation algorithm, preparing the initial quantum states comprises performing further quantum computation described in more detail below.

At step 902, all of the TQGs that it is possible to perform based on the current locations of qubit states within the connected qubit pairs are performed and the order in which TQGs must be performed in a quantum Fourier transform.

The order in which TQGs must be performed may be a sequence of individual TQGs, or may be a sequence of groups of one or more TQGs that can be performed in parallel, in which case “performing all TQGs that can be performed” includes performing all groups from the sequence that can be fully performed based on the current positions of the qubit states within the qubits.

The order in which TQGs must be performed corresponds to the usual order in which controlled rotation gates are performed in a QFT, such as depicted in FIG. 5.1 of the textbook “Quantum Computation and Quantum Information”, 10th Anniversary Edition, Michael Nielsen and Isaac Chuang. Many of these TQGs can be performed in parallel. In this case, the TQGs that can be performed in parallel is based on the current positions of qubit states within the qubits and others may not, in which case those that are possible may be performed at step 902. For example, TQGs on qubit pairs [q₁, q₂], [q₁, q₃] and [q₂, q₄] can be performed based on the current positions of the qubit states; however, while the TQG on qubit pair [q₁, q₄] can be performed in parallel with the TQG on qubit pair [q₂, q₄] according to the order strictly required in a quantum Fourier transform, it cannot be performed based on the current positions of qubit states within the qubits before any SWAPs are performed.

Where the order is a sequence of groups of TQGs that can be performed in parallel, the TQGs in the group are performed only when all of the TQGs in the group can be performed at the same time. For example, the TQGs on pairs [q₀, q₃] and [q₁, q₂] are in the same group in the sequence because they can be performed in parallel, thus even though the TQG on [q₁, q₂] can be performed before the first SWAP, it is not performed until after, where it can be performed in parallel with the TQG on [q₀, q₃].

As an illustrative example, for a system of 8 qubits as depicted in FIG. 7, the TQGs that can be performed in parallel can be arranged into a table as follows, where each row represents one of the group of TQGs that can be performed in parallel:

| | q₀ | q₁ | q₂ | q₃ | q₄ | ₉₅ | q₆ |
|---|---|---|---|---|---|---|---|
| Group 1 | q₀, q₁ | | | | | | |
| Group 2 | q₀, q₂ | | | | | | |
| Group 3 | q₀, q₃ | q₁, q₂ | | | | | |
| Group 4 | q₀, q₄ | q₁, q₃ | | | | | |
| Group 5 | q₀, q₅ | q₁, q₄ | q₂, q₃ | | | | |
| Group 6 | q₀, q₆ | q₁, q₅ | q₂, q₄ | | | | |
| Group 7 | q₀, q₇ | q₁, q₆ | q₂, q₅ | q₃, q₄ | | | |
| Group 8 | | q₁, q₇ | q₂, q₆ | q₃, q₅ | | | |
| Group 9 | | | q₂, q₇ | q₃, q₆ | q₄, q₅ | | |
| Group 10 | | | | q₃, q₇ | q₄, q₆ | | |
| Group 11 | | | | | q₄, q₇ | q₅, q₆ | |
| Group 12 | | | | | | q₅, q₇ | |
| Group 13 | | | | | | | q₆, q₇ |

At step 903, after all of the possible TQGs have been performed, if k is even SWAP gates are performed between all pairs of qubits [q_{c}, q_{c+2}], where c is even, c/2 is even and c/2≤n. If n is odd, SWAP gates are performed between all pairs of qubits [q_{d}, q_{d+2}], where d is odd, (d+1)/2 is even, and (d+1)/2≤n. For the first iteration of steps 902 and 903, k=1.

Following each SWAP, the qubit states associated with each qubit before the SWAP are swapped and it may be possible to perform further TQGs based on the new locations of the qubit states within the qubits and the connections available between the qubits.

After each iteration of step 903, n is incremented by 1 and steps 902 and 903 are repeated until k is equal to the ceiling of (m−1)/2, where m is the number of qubits, i.e. if the result of (m−1)/2 is not a whole number, it is rounded up to the nearest whole number greater than (m−1)/2.

After steps 902 and 903 have been repeated until k=[(m−1)/2], there may still be some TQGs that need to be performed. If so, at step 904 the process returns to step 902 and 903, with k=1, and the iterative application of steps 902 and 903 described above repeats. If, on any loop, all of the TQGs are performed before k reaches [(m−1)/2], the process may move on to step 905.

At an optional step 905, all of the SWAPs performed in the iterations of step 903 may be performed in reverse order, such that the locations of the qubit states within the qubits are restored to their “correct” locations, i.e. the locations that those states would be expected in the idealised all-to-all topology with no SWAPs.

The same procedure can be applied in reverse to perform an inverse quantum Fourier transform, as required in the quantum phase estimation algorithm.

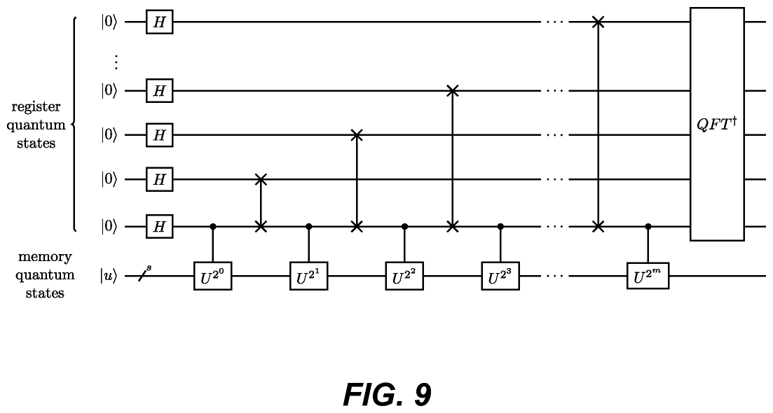

FIG. 9 is a quantum circuit diagram showing an algorithm for performing quantum phase estimation using the QPUs described above. The quantum circuit diagram includes a number of register quantum states represented by the quantum wires at the top of the quantum circuit diagram. A plurality of memory quantum states are represented by the single combined wire at the bottom of the circuit diagram. The method of performing quantum phase estimation begins by performing a Hadamard gate on each quantum state in a plurality of register quantum states. The register quantum states have all been previously initialized in the ground state |0 [symbol] . In total m+1 register quantum states are stored in the first qubit q₀ and first subset of second qubits q₁ to qₘ, with each of the first qubit q₀ and qubits in the first subset of second qubits storing one of the register quantum states.

Performing controlled operations, also referred to as “controlled-U” operations, are subsequently performed on the plurality of memory quantum states. The memory quantum states are stored in the second subset of second qubits. Each of the n memory quantum states is stored in one of the qₘ₊₁ to qₘ₊ₙ qubits of the second subset of second qubits. Each controlled operation depends on the state of a different one of the register quantum states, thus the controlled operations are performed by repeatedly swapping the register quantum state stored in the first qubit q₀ and performing each controlled operation on the first qubit and second subset of second qubits.

The controlled operation corresponds to a unitary (U), and the initial state of the memory quantum states corresponds to an eigenstate (|u [symbol] ) of the unitary. The quantum phase estimation algorithm estimates the eigenvalue of the eigenstate |u [symbol] .

Further details on the controlled operation can be found in Chapter 5, part 5.2 of “Quantum Computation and Quantum Information”, Michael Nielsen & Isaac Chuang, ISBN 978-1-107-00217-3.

After the controlled operations have been performed, an inverse quantum Fourier transform is performed on the register quantum states, for example as described above with respect to FIG. 8.

If the quantum phase estimation is the final step of the quantum algorithm then the method may comprise a final step of measuring the states of the second qubits in which the register quantum states are stored.

Furthermore, if the quantum phase estimation algorithm is performed as part of the Harrow-Hassidim-Lloyd algorithm, then one of the first subset of second qubits or one of the second subset of second qubits may be used as an ancilla qubit for performing the ancilla quantum encoding subroutine of the HHL algorithm, as described in more detail in Martin, A., Ibarrondo, R., & Sanz, M. (2022). Digital-analog co-design of the Harrow-Hassidim-Lloyd algorithm. arXiv. https://doi.org/10.48550/ARXIV.2207.13528.

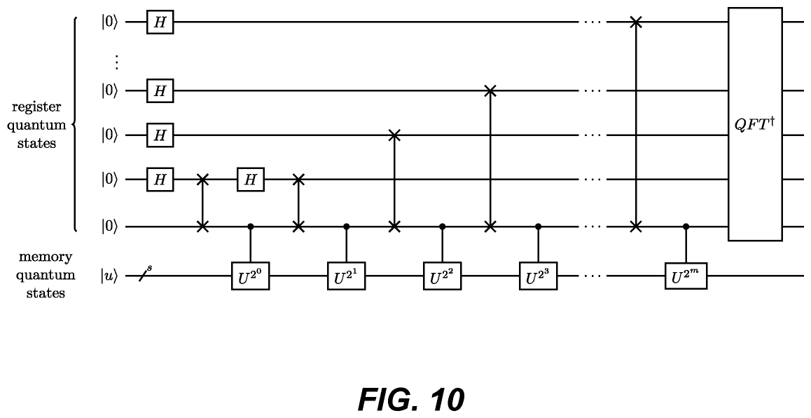

FIG. 10 shows a modified version of the quantum circuit of FIG. 9, which takes into account the use of a resonator as the first qubit q₀ as depicted in FIGS. 2-6 described above. Where a resonator is used as the central qubit q₀, it is in general not possible to perform a single-qubit gate such as a Hadamard gate on the quantum state stored in the resonator. In the quantum circuit diagram of FIG. 10, the bottom quantum wire in the group of register quantum states corresponds to the central qubit q₀. At a first step of the method, Hadamard gates are performed on all qubits in the first subset of second qubits. Then, the states of the first qubit q₀ and one of the qubits in the first subset of second qubits are swapped and a Hadamard gate is performed on the qubit in the first subset of second qubits into which the quantum state originally stored in the resonator was swapped. It does not matter which of the qubits in the first subset of second qubits is used for the swap, as following the swap and Hadamard gate process, all of the register quantum states are in the same superposition of basis states generated by the Hadamard gate.

The remaining steps of the quantum phase estimation algorithm described above with respect to FIG. 9 process in the same manner in the algorithm of FIG. 10. It is possible to perform the first controlled operation on the memory states in parallel with the second Hadamard gate, since the register state stored in the resonator after the first swap is already in the correct superposition of basis states.

The topology of the QPUs of FIGS. 1-6 described above are particularly suited to performing the quantum phase estimation algorithm. There are many ways to compile the controlled operations from the abstract form shown in FIGS. 9 and 10 to single- and two-qubit gates that are performed by the QPU. One way of compiling these controlled operations is to take a circuit implementing the unitary “U” in single- and two-qubit gates. Then, a control is added to singe-qubit gates, converting them into two-qubit gates, that always have a control in the corresponding register quantum state. This introduces a very large number of two-qubit gates on a register quantum state and a memory quantum state. The number of register quantum states determines the accuracy of the quantum phase estimation algorithm, thus a larger number m+1 of controlled operations must be performed to improve the accuracy of the algorithm. The algorithm can be efficiently performed on the QPUs depicted in FIGS. 1-6 with a single or very small number of swaps between each controlled operation to place the required register quantum state in the first qubit q₀. This significantly decreases circuit depth compared to performing the algorithm on non-specialised QPUs.

Where the first subset of second qubits and second subset of second qubits are connected by at least one direct coupling, as shown by dashed lines in FIGS. 1, 2 and 6, then the number of second qubits used to store register quantum states may be larger than the number of qubits in the first subset of second qubits by using some of the second subset of second qubits to store register quantum states as well as the first subset of second qubits Alternatively, the number of second quantum states used to store the memory quantum states may be larger than the number of qubits in the second subset of second qubits by using some of the first subset of second qubits to store memory quantum states as well the second subset of second qubits.

1. A quantum processing unit for performing a quantum phase estimation algorithm, the quantum processing unit comprising a first qubit (q₀) and a plurality of second qubits (q₁ to qₘ₊ₙ), wherein:
the plurality of second qubits comprises a first subset of second qubits (q₁ to qₘ) and a second subset of second qubits (qₘ₊₁ to qₘ₊ₙ);
the first qubit is directly coupled to a plurality of second qubits in the first subset of second qubits;
the first qubit is directly coupled to a plurality of second qubits in the second subset of second qubits;
each second qubit in the first subset of second qubits is coupled directly or indirectly to every other second qubit in the first subset of second qubits via one or more other second qubits in the first subset of second qubits; and
each second qubit in the second subset of second qubits is coupled directly or indirectly to every other second qubit in the second subset of second qubits via one or more other second qubits in the second subset of second qubits.

2. The quantum processing unit of claim 1, wherein the first qubit (q₀) is directly coupled to every qubit in the first subset of second qubits (q₁ to qₘ), and/or wherein the first qubit (q₀) is directly coupled to every qubit in the second subset of second qubits (qₘ₊₁ to qₘ₊ₙ).

3. The quantum processing unit of claim 1, wherein the first subset of second qubits (q₁ to qₘ) and the second subset of second qubits (qₘ₊₁ to qₘ₊ₙ) are connected such that each of the second qubits is coupled directly or indirectly to every other second qubit via other second qubits.

4. The quantum processing unit of claim 3, wherein at least one second qubit of the first subset of second qubits (q₁ to qₘ) is directly coupled to one second qubit of the second subset of second qubits (qₘ₊₁ to qₘ₊ₙ).

5. The quantum processing unit of claim 4, wherein only one second qubit of the first subset of second qubits (q₁ to qₘ) is directly coupled to one second qubit of the second subset of second qubits (qₘ₊₁ to qₘ₊ₙ).

6. The quantum processing unit of claim 4, wherein:
two second qubits of the first subset of second qubits (q₁ to qₘ) are directly coupled to second qubits of the second subset of second qubits (qₘ₊₁ to qₘ₊ₙ), such that each second qubit of the first subset of second qubits is directly coupled to one second qubit of the second subset of second qubits, and each second qubit of the first subset of second qubits is directly coupled to a different second qubit of the second subset of second qubits.

7. The quantum processing unit of claim 1, wherein the second qubits in the first subset of second qubits (q₁ to qₘ) are coupled in a first two-degree chain such that a first and last second qubits in the first two-degree chain are directly coupled to one other second qubit in the first subset of second qubits, and all other second qubits in the first two-degree chain are connected to two other second qubits in the first subset of second qubits.

8. The quantum processing unit of claim 1, wherein the second qubits in the first subset of second qubits (q₁ to qₘ) are arranged in a four-degree chain such that all second qubits q except for second qubits q₁, q₂, qₘ₋₁ and qₘ are connected to four other second qubits qₖ₋₂, qₖ₋₁, qₖ₊₁ and qₖ₊₂.

9. The quantum processing unit of claim 1, wherein the second qubits in the second subset of second qubits (qₘ₊₁ to qₘ₊ₙ) are coupled in a second two-degree chain such that a first and last second qubits in the second two-degree chain are directly coupled to one other second qubit in the second subset of second qubits, and all other second qubits in the second two-degree chain are connected to two other second qubits in the second subset of second qubits.

10. The quantum processing unit of claim 9, wherein one or more of:
the first second qubit in the first two-degree chain is directly coupled to the first second qubit in the second two-degree chain; and
the last second qubit in the first two-degree chain is directly coupled to the last second qubit in the second two-degree chain.

11. The quantum processing unit of claim 1, wherein the first qubit (q₀) is physically configured as at least one resonator.

12. The quantum processing unit of claim 11, wherein the second qubits (q₁ to qₘ₊ₙ) are coupled to the at least one resonator at positions corresponding to maxima of a standing electromagnetic wave formed within the at least one resonator.

13. A method for performing a quantum phase estimation algorithm on a quantum processing unit comprising a first qubit (q₀) and a plurality of second qubits (q₁ to qₘ₊ₙ), wherein:
the plurality of second qubits comprises a first subset of second qubits (q₁ to qₘ) and a second subset of second qubits (qₘ₊₁ to qₘ₊ₙ);
the first qubit is directly coupled to a plurality of second qubits in the first subset of second qubits;
the first qubit is directly coupled to a plurality of second qubits in the second subset of second qubits;
each second qubit in the first subset of second qubits is coupled directly or indirectly to every other second qubit in the first subset of second qubits via one or more other second qubits in the first subset of second qubits; and
each second qubit in the second subset of second qubits is coupled directly or indirectly to every other second qubit in the second subset of second qubits via one or more other second qubits in the second subset of second qubits;
the method comprising:
performing a Hadamard gate on each quantum state in a plurality of register quantum states, each of which has been initialized in a ground state |0>, wherein the register quantum states are stored in the first subset of second qubits (q₁ to qₘ) and in the first qubit (q₀);
performing controlled operations on a plurality of memory quantum states stored in the second subset of second qubits (qₘ₊₁ to qₘ₊ₙ) by repeatedly swapping the register quantum state stored in the first qubit and performing each controlled operation on the first qubit and the second subset of second qubits, wherein each controlled operation depending on a state of a different one of the register quantum states, wherein the controlled operation corresponds to a unitary (U), and wherein an initial state of the memory quantum states corresponds to an eigenstate (|u>) of the unitary; and
performing an inverse quantum Fourier transform on the register quantum states.

14. The method of claim 13, wherein the method further comprises measuring the register quantum states to obtain the eigenvalue of the eigenstate (|u>) of the unitary (U).

15. The method of claim 13, wherein the controlled operation applies the unitary to the memory quantum states only if the quantum state of the first qubit is |1>.

16. The method of claim 13, wherein the first qubit (q₀) is physically configured as at least one resonator and the register quantum states are stored in the first subset of second qubits (q₁ to qₘ) and in the first qubit (q₀), and wherein performing a Hadamard gate on each quantum state in the plurality of register quantum states comprises:
performing Hadamard gates on the register quantum states in the first subset of second qubits (q₁ to qₘ);
swapping the register quantum states of the first qubit (q₀) and one second qubit of the first subset of second qubits; and
performing a Hadamard gate on the swapped quantum state originally in the first qubit (q₀).

17. The method of claim 13, wherein at least one second qubit of the first subset of second qubits (q₁ to qₘ) is directly coupled to one second qubit of the second subset of second qubits (qₘ₊₁ to qₘ₊ₙ), and wherein either:
the register quantum states are also stored in some of the second qubits of the second subset of second qubits; or
the memory quantum states are also stored in some of the second qubits of the first subset of second qubits.

18. The method of claim 17, wherein the method further comprises selecting a number of second qubits used to store the register quantum states and/or a number of second qubits used to store the memory quantum states.

19. The method of claim 13, wherein the quantum phase estimation algorithm is performed as part of a Harrow-Hassidim-Lloyd algorithm, and wherein one second qubit from the first subset of second qubits (q₁ to qₘ) or one second qubit from the second subset of second qubits (qₘ₊₁ to qₘ₊ₙ) is used as an ancillary qubit for performing the ancilla quantum encoding subroutine of the Harrow-Hassidim-Lloyd algorithm.

20. A computer system comprising a quantum processing unit for performing a quantum phase estimation algorithm, the quantum processing unit comprising a first qubit (q₀) and a plurality of second qubits (q₁ to qₘ₊ₙ), wherein:
the plurality of second qubits comprises a first subset of second qubits (q₁ to qₘ) and a second subset of second qubits (qₘ₊₁ to qₘ₊ₙ);
the first qubit is directly coupled to a plurality of second qubits in the first subset of second qubits;
the first qubit is directly coupled to a plurality of second qubits in the second subset of second qubits;
each second qubit in the first subset of second qubits is coupled directly or indirectly to every other second qubit in the first subset of second qubits via one or more other second qubits in the first subset of second qubits; and
each second qubit in the second subset of second qubits is coupled directly or indirectly to every other second qubit in the second subset of second qubits via one or more other second qubits in the second subset of second qubits;
and wherein the computer system is configured to perform a method comprising:
performing a Hadamard gate on each quantum state in a plurality of register quantum states, each of which has been initialized in a ground state |0>, wherein the register quantum states are stored in the first subset of second qubits (q₁ to qₘ) and in the first qubit (q₀);
performing controlled operations on a plurality of memory quantum states stored in the second subset of second qubits (qₘ₊₁ to qₘ₊ₙ) by repeatedly swapping the register quantum state stored in the first qubit and performing each controlled operation on the first qubit and the second subset of second qubits, wherein each controlled operation depending on a state of a different one of the register quantum states, wherein the controlled operation corresponds to a unitary (U), and wherein an initial state of the memory quantum states corresponds to an eigenstate (|u>) of the unitary; and
performing an inverse quantum Fourier transform on the register quantum states.
